(19) United States
(12) Patent Application Publication
(10) Pub. No.: US 2007/0077421 A1
(43) Pub. Date: Apr. 5, 2007

(54) Surface protection film

(75) Inventors: Achim Grefenstein, Altrip (DE); Frederic Wypelier, Marly (FR); Jean-Louis Lemaire, Ennevelin (FR)

Correspondence Address: FOLEY AND LARDNER LLP;SUITE 500, 3000 K STREET NW, WASHINGTON, DC, 20007, US

(73) Assignees: RKW AG RHEINISCHE; KUNSTSTOFFWERKE

(21) Appl. No.: 11/524,538

(22) Filed: Sep. 21, 2006

(30) Foreign Application Priority Data
Sep. 21, 2005 (EP) 05 020 556.6

(51) Int. Cl. B32B 7/12

(52) U.S. Cl. 428/355 R

(57) ABSTRACT

A self adhesive extruded multilayer surface protection film comprises a base layer and an adhesive layer consisting essentially of at least one copolymer of ethylene with one or more α-olefins having 4 to 10 carbon atoms, with a density of 0.86 g/cm³ to 0.90 g/cm³, whereby at least one of them has a peak melting temperature of ≦50° C.

### CROSS-REFERENCE TO RELATED PATENT APPLICATIONS

The right of foreign priority is claimed under 35 U.S.C. § 119(a) based on European Patent Office Priority Application 05 020 556.6, filed Sep. 21, 2005, the entire contents of which, including the specification, drawings, claims and abstract, are incorporated herein by reference.

### BACKGROUND OF THE INVENTION

The present invention relates to films used for protection of surfaces.

It is common practice to protect sensitive surfaces like glass, lacquers or plastic with self adhesive surface protection films. These surface protection films have to fulfill certain requirements. They should
be flexible and able to conform to the surface contour
adhere to the surface sufficiently to prevent a premature loosening
be easy to remove without residue once the protection is no longer necessary
be inert towards the surface so that even during long contact with the surface no marking or other changes of the protected surface occur.

In the protection of thermoformable sheets, a constant adhesive force after thermoforming and ageing and the ability to remove the protection film and put it back once again is required additionally.

One proposed and widespread solution for surface protection of substrates is to use a film coated with an adhesive. Surface protection films are therefore today to a large extend coated with mostly acrylic adhesive. However acrylic adhesive and all adhesives in general tend to migrate to the substrate. Furthermore, the cost for the 2-step production is high. This renders adhesive coated films problematic for applications like protection of thermoformable sheets, where the requirements of no migration to the surface of the substrate and resistance to ageing are of major importance.

Another proposal is the use of coextruded multilayer films. Those films comprise at least two layers, one serving as the protective surface and providing the films strength and the second providing sufficient adhesion to the surface of the substrate. One typically used coextruded film comprises ethylene vinyl acetate as adhesive layer. Existing coextruded films show either an increasing or decreasing adhesion level after heat storage and/or thermoforming, which is not acceptable for many applications.

Another approach uses tackifiers to provide sufficient adhesion of the film to the substrate. Formulations based on tackifiers (e.g. hydrocarbon resin Escorez from Exxon) often show migration to the substrate, especially after thermoforming.

Other existing solutions have too low adhesion forces in general or non-constant values in general (like corona-treated films).

Some prior art approaches are summarized in the following.

From DE 27 18 510 it is known to provide the surfaces of thermoplastic plastics sheets of polymethylmethacrylate (PMMA) with a protective film after manufacture, this film being produced from low density polyethylene having a melt index between 1 and 4 g/10 min and being pretreated on the adhesive side by corona discharge in order to improve the adhesion of the film to the plastic sheet. At a surface temperature of 60-100° C. the adhesion of this protective film is, however, highly variable, with the result that it may become detached at the edges or even over the entire surface. At the other extreme, the film may be torn as it is pulled away from the sheets or moldings. The wide variability in adhesion of such films depends on the surface temperature of the sheet during application of the film and additionally on the nature of the surface of the film, e.g., microscopic variations in the surface in the case of blown film, as well as fluctuations in the intensity of pretreatment and tolerances in the polyethylene granules caused by the manufacturing process.

U.S. Pat. No. 5,275,866 and No.5,279,883 disclose self adhesive surface protection films of polyethylene, one surface of which is subjected to corona pretreatment at between 40 and 44 mN/m, and which are subsequently provided with a coating of an adhesive based on polyacrylic acid esters or based on natural rubber. The self adhesive surface protection films are indeed characterized by uniform and more reproducible adhesion to sheets of plastics, but as a result of thermal stresses during storage or during thermoforming, slight traces of adhesive may be left on the edges when the protective film is torn off quickly, and these traces are visible on transparent objects such as light shades.

It is further known to use two-layer or multi-layered protective films produced by coextrusion, having an adhesive layer of ethylene-vinyl acetate copolymer as surface protection films. EP 761 315, EP 826 754, DE 100 07 060 and EP 1 326 937 are examples. In practice, it has been found that two-layer or multi-layered polyethylene protective films produced by coextrusion, having an adhesive layer of ethylene-vinyl acetate copolymer with a vinyl acetate content of about 18% by weight, react to temperature increases during storage and transportation and particularly during thermoforming by adhering much more strongly to the plastic sheets. If the vinyl acetate content of the adhesive layer is lower, e.g., 9% by weight, the adhesion at ambient temperature is insufficient for working of the sheets by cutting, milling or drilling, with the result that the film lifts in the areas adjoining the machined edges. An increase in the degree of adhesion can be achieved by the known process of corona pretreatment, but here again the significant increase in adhesion as the temperature rises is a disadvantage. During thermoforming, in particular, the increase in adhesion as a result of the reduction in the film thickness in the deep-drawn areas of moldings is detrimental in that the protective film tears easily when it is removed by the end user.

In DE 43 11 322 it is proposed to add one or more resins increasing the tack to an adhesive layer from ethylene vinyl acetate, polyethylene or mixtures thereof. However, tackifiers tend to migrate to the substrates, which is unacceptable.

In EP 608 175 an adhesive mass is described, comprising either a mixture of at least one polyolefin with a tackifier or comprising a mixture of a copolymer of ethylene and propylene with a copolymer of ethylene with an olefin such as butene, hexene or octene or with an ethylene vinyl acetate. Example 3 mentions a surface protection film made with 100 parts of ethylene octene copolymer and 10 parts of ethylene propylene copolymer. The film shows an adhesion of 0.1-0.2 N/cm on PMMA. The adhesion is said to remain constant during thermoforming. This adhesion is too low, and when a tackifier is used to reach sufficient adhesion, migration problems occur.

EP 1 388 582 describes polyisobutylene and/or styrene block copolymer as an adhesive layer. These films work well but are comparatively expensive.

EP 661 364 proposes the use of an adhesive layer based on a ternary copolymer of propylene, 1-butene, and an α-olefin with 5-12 C-atoms, with <10% crystallinity and >0.04 N/cm initial tack on steel plates. The ternary copolymer can be mixed with a binary copolymer or styrenic polymers.

Other suggestions include the use of butyl rubber or styrene butadiene styrene copolymer, styrene isoprene styrene block copolymer and tackifiers and/or polybutadiene or polyisobutylene as softeners.

EP 1 260 566 describes mixtures of low density polyethylene, polyethylene copolymers (with olefins, polypropylene, polypropylene and dienes, vinyl acetate, acryl, styrene, butadiene), styrene butadiene styrene copolymer, styrene isoprene styrene copolymers and or tackifiers with polyisobutenes and/or block copolymers with at least two blocks with aromatic structure and one block of diene. The examples mention copolymers of ethylene with olefins plus styrenic resins/tackifiers. The films are made in the blown process and peel forces between 0.1 and 3 N/cm are claimed to be achieved. Products containing dienes (double-bonds) are more sensitive to thermal or oxidative ageing. Furthermore the price of such formulations is relatively high.

DE 101 16 438 claims self adhesive surface protection films especially suitable for protecting the lacquer of cars, comprising an adhesive layer containing a polymer from at least two different α-olefins, whereby the polymer does not contain 75% by mole or more of one single monomer and has a Mooney-viscosity ML (1+4) 125° C. of at least 50. The examples only show films with an adhesive layer made of ethylene, propylene and 5-ethylidene-2-norbornene. Nothing is said in relation to peel strength after thermal impact of more than 90° C. According to this patent the adhesive layer is either coated onto the base layer(s) or the materials have to be powdered, e.g., with amorphous silica to effect coextrusion. Both approaches are costly.

JP 2000-144069 proposes surface protective films with an adhesive layer from mixtures of (a) 75-95% by weight polyethylene-based resin showing only one crystalline melting peak and a temperature interval of not more than 20° C. up to complete melting and with a density of 0.900-0.920 g/cm³ with (b) 5-25% polyethylene based resin showing only one crystalline melting peak and a temperature interval of not more than 20° C. up to complete melting and with a density of less than 0.900 g/cm and (c) 0.1 to 0.4 parts by weight of tackifying resin based on 100 parts by weight of resins (a) and (b). These adhesive layers need a tackifier for sufficient adhesion.

In EP 1 520 690 adhesive layers consisting essentially of linear low density polyethylene are described, whereby copolymers of ethylene are also mentioned. The polyethylenes have a content of n-hexane extractable material of 3 to 15% by weight, which is not desirable. A minor admixture of polyolefin plastomers, polyolefin elastomers or polyethylene polymerized with metallocene catalysts is possible. No information as to the specific use as protective films during thermoforming is given. The mentioned use is combined with imprinted layers as decorative or advertising films to be fixed on windows from the inside, and combined with an additional adhesive layer as an adhesive film for fixing posters.

### SUMMARY OF THE INVENTION

Therefore, it is an object of the present invention to provide surface protection films that are cost effective and solve the problems stated above for the known films.

Surprisingly this object is accomplished by a multilayer film comprising an adhesive layer consisting essentially of at least one copolymer of ethylene with an α-olefin with 4 to 10 carbon atoms having a density of 0.86 to 0.90 g/cm³, whereby at least one of the copolymers has a peak melting temperature of ≦50° C.

Further objects, features and advantages of the present invention will become apparent from the detailed description of preferred embodiments that follows.

### DETAILED DESCRIPTION OF THE PREFERRED EMBODIMENTS

The surface protection films of the invention are characterized by one or more of the following properties:
constant and high adhesion force adjustable up-to values of 3 N/cm depending on the substrate
no or very low change after heat storage at, e.g., 80° C. for 24 h or 1 week
no change after thermoforming
no ageing, especially no ageing caused by double bonds
film can be removed and sticks once again on the surface
no migration even after heat storage of at least one week at 80° C.
a protection film that provides a good diffusion of moisture and no absorption of moisture (<0.01% according to DIN 53495 method 1) in the adhesive layer
highly transparent protection film

The copolymers of ethylene with an α-olefin with 4 to 10 carbon atoms, designated plastomers in the following, that are suitable for the present invention have a low density and a low peak melting temperature. As a rule, a lower peak melting temperature provides a higher tack of the film. The peak melting temperature is preferably ≦40° C. The peak melting temperature is measured by DSC analysis according to ISO 11357 with a heating rate of 10 K per min.

It is possible to use two or even more plastomers, whereby either all have a peak melting temperature ≦50° C. or where not all of them but at least one of them has a peak melting temperature ≦50° C.

One parameter influencing the peak melting temperature is the content of the comonomer within the plastomer. Preferably the content of the comonomer is ≧20% by weight, especially preferred ≧23% by weight. The comonomer content may be measured according to ASTM D-2238, method B. The content of ethylene is preferably ≧80% by mole.

The comonomer is chosen among α-olefins with 4 to 10 carbon atoms, such as butene, pentene, hexene, heptene, octene, nonene and decene. Preferred are octene, hexene and butene, and especially preferred is octene. It is possible that two or more comonomers are present.

Suitable products are, e.g., the Exact grades (ethylene octene copolymers) from Exxon Mobil Corp. or the Engage grades from Dow Plastics (ethylene octene or ethylene butene copolymers, now also designated Affinity). Very soft products like Engage are sometimes also designated Elastomers. A description of suitable plastomers from DOW Plastics can be found, e.g. in U.S. Pat. Nos. 5,272,236 and 5,278,272, which are incorporated by reference herein.

Mixing with other plastomers with a higher melting temperature, e.g., 50 to 120° C., is possible to adjust the adhesion force at lower values, if desirable. Depending on the required adhesion level, a content of higher melting products up-to 95% can be used. Preferred are contents of plastomers with higher melting temperature up to 80% by weight, and especially preferred up to 50% by weight.

Optionally, additives known per se, such as fillers, pigments, UV absorbers, antioxidants, heat stabilizers and/or lubricants, can be present in the adhesive layer and/or in the base layer(s). Additives are preferably used in the amounts recommended by the suppliers.

In one preferred embodiment the base layer, or an outer layer in the case of a three or more layer film, contains an antiblock agent. With the adhesive layer according to the invention it is possible to achieve a sufficient release with comparatively low contents of antiblock agents, such as, for example, silicates, in an amount below 10% by weight, preferably below 5% by weight and especially preferred below 2% by weight.

Surprisingly and in contrast to the prior art, it was found that it is not necessary to mix a plastomer with another component, such as a second polymer or a tackifier, in order to achieve high levels of tack. It is sufficient to use a plastomer with a peak melting point low enough. Therefore, the adhesive layer is preferably free of tackifiers and does not contain or essentially does not contain polymers other than copolymers of ethylene with α-olefins.

The molecular weight distribution is preferably narrow, with Mw/Mn ≦4. The content of oligomers with molecular weights lower than 1000 is preferably as low as possible.

The adhesion of the films according to the invention can be varied to suit the intended application. Generally it is chosen between from 0.1 to 2 N/cm, preferably from 0.1 to 1.5 N/cm and especially preferred from 0.2 to 1 N/cm. This adhesion is not altered significantly during storage for a long time and/or at temperatures as high as 80° C. or even 100° C. Typically the adhesion will change not more than 100%, especially not more than 50%.

The film according to the invention has the additional advantage that its adhesive layer is compatible with most grades of polyethylene and polypropylene.

Films according to the invention are well suited for the temporary protection of thermoformed sheets of polymethylmethacrylate, polycarbonate, styrene-acrylonitrile, acrylonitrile-butadiene-styrene terpolymer, polystyrene and for replacement of soft polyvinylchloride films, with and without printing, for advertisement and protection of, e.g., mobile phone displays, etc. They show a high transparency, as has been tested with haze measurements.

Further, with an addition of a UV-stabilizer and optionally pigments, such as titanium dioxide, the films according to the invention are useful for protecting the lacquer of automobiles or window panes during transport.

The films according to the invention can be produced in a conventional manner, e.g., on a conventional blown film line or cast film line. However, provisions should be made that the adhesive layer does not stick on one of the different rollers, knives or other devices being in contact with this layer. The extrusion parameters, such as temperature, output, etc., are in the typical range for polyethylene blown or cast films.

The invention will be explained further with the following examples, which are not meant to restrict its scope, however. All parts and percentages are by weight except where stated otherwise.

### EXAMPLE 1

A three layer blown coextruded film is prepared with a first layer of low density polyethylene, a second layer of low density polyethylene and a third (adhesive) layer of a plastomer. The film has an overall thickness of 60 μm.

For comparison, further films are prepared in the same manner with differing adhesive layers. One adhesive layer is a corona-treated film of linear low density polyethylene (comonomer C8-olefin), another is a plastomer with a peak melting point of 71° C. Additionally, a blown three-layer film with EVA 45% (Levamelt 450 from Lanxess) as adhesive layer is produced.

The peel adhesion for the films is measured by laminating a test sample of the film on a thermoformable polymethylmethacrylate (PMMA) sheet (Degussa XT sheet) for several test samples from the film roll. Test samples are prepared out of a bundle of film cut from the film roll, which extends at least 10 to 15 layers of the roll. Test samples 290 mm×210 mm are extracted from the left, right and two times from the middle of the film roll. The test samples are laminated to the sheet not earlier than 1 day after production, with the machine direction of the film parallel to the machine direction of the sheet. The temperature of the sheet during lamination is 70° C. The pressure of the laminating device is set to 400 N and the temperature of the rolls to 70° C. or 23° C. The line speed is adjusted to approximately 1 m/min and the film is fed to the heated roll. The gap is passed three times, forward-backward-forward.

The adhesion force is then measured with a standard tearing machine, e.g., from Instron. The specimen respective the protection film is cut into stripes of each 50 mm width before tearing them of. The haul-off speed is set to 500 mm/min, the angle to 180° in the machine direction. The obtained force is normalized with the sample dimension to obtain the adhesion force. Tests are performed directly after sample preparation and 24 h, 1 week and 4 weeks after sample preparation. Additionally, samples are stored in an oven at 80° C. for 24 h, 1 week and 4 weeks, and the adhesion force is measured as described after cooling them to room temperature.

The results are displayed in table 1.

TABLE 1
Peel forces on thermoformable PMMA sheet

| | | After heat storage |
|---|---|---|
| Blown films with an | Initial peel | 24 h @ 80° C. |
| adhesive layer made of . . . | force (N/cm) | (N/cm) |
| Plastomer, | 1.20 | 1.08 |
| peak melting point 36° C. | | |
| Plastomer, | 0.90 | 1.06 |
| peak melting point 36° C., | | |
| (laminated at 23° C.) | | |
| Corona-treated LLDPE | 0.36 | 0.02 |
| (42 dyne) | | |
| Plastomer, | 0.10 | 0.08 |
| peak melting point 71° C. | | |
| Plastomer, | 1.05 | 0.79 |
| peak melting point 71° C., | | |
| plus tackifier resin | | |
| Plastomer, | 1.12 | 0.53 |
| peak melting point 71° C., | | |
| plus tackifier resin | | |
| (laminated at 23° C.) | | |
| EVA (45% VA) | 1.60 | 3.07 |

It is obvious that only the products according to the invention show more or less constant values of the peel force between 0.9 and 1.2 N/cm, even after heat storage. The corona treated film has inferior adherence, and its adhesive force is reduced dramatically after heat storage (confirmed for different corona levels of 38 to 48 dyne). Plastomers with higher peak melting point show too low of an adhesion force as well. By using an additional tackifier it seems to be possible to increase the initial tack, however after heat exposure there is a remarkable decrease, especially when cold laminated.

The film with EVA as adhesive shows a high initial tack (1.6 N/cm) comparable to the films according to the invention, but an undesired increase after heat storage of 24 hours at 80° C. (3.07 N/cm) occurs.

### EXAMPLE 2

Some films of Example 1 are laminated on coextruded sheets with a top layer of clear styrene acrylonitrile, based on α-methylstyrene on a black blend including acrylonitrile styrene acrylic terpolymer and polycarbonate. The speed of the extrusion line is 1 m/min, the width 700 mm, and the overall thickness of the sheet 1.3 mm. The temperature at the lamination point is 32° C.

The produced sheets are cut with a saw and thermoformed on a single station machine from Illig Company, with a forming temperature of 140° C. The heating time is adjusted to 40 s. After that, the adhesion force is measured according to Example 1 in a non-stretched area of the part (side) and in a stretched area of the part (middle).

The results are displayed in table 2. The values represent the adhesion force for the laminates before thermoforming, after thermoforming before storage and after heat storage at 80° C. for 24 h and after heat storage at 80° C. for 1 week.

TABLE 2
Peel forces on SAN sheet after application on extrusion line

| | Plastomer with | Plastomer with | |
|---|---|---|---|
| | peak melting | peak melting | |
| Peel forces | point of | point of | Corona-treated |
| in N/cm | 36° C. | 71° C. | LLDPE (42 dyne) |
| Before | 0.96 | 0.03 | 0.07 |
| thermoforming | | | |
| thermoformed | 1.48 | 0.04 | 0.38 |
| middle | | | |
| middle | 1.47 | 0.03 | 0.16 |
| 80° C./24 h | | | |
| middle | 1.82 | 0.02 | 0.16 |
| 80° C./1 wk | | | |
| thermoformed | 1.07 | 0.02 | 0.44 |
| side | | | |
| side | 1.45 | 0.03 | 0.03 |
| 80° C./24 h | | | |
| side | 1.58 | 0.02 | 0.03 |
| 80° C./1 wk | | | |

It can be seen that both comparison examples show much lower peel strength. Furthermore, the loss of adhesion after heat storage of the corona-treated film is demonstrated once again.

Only the sample according to the invention guarantees that the protection film sticks properly on the substrate during all process steps and can then be easily removed from the thermoformed part as well.

After one week of heat storage of the black thermoformed parts, the film according to the invention shows no markings (due to migration), whereas the corona-treated film of LLDPE shows the first migration of volatiles to the substrate.

### EXAMPLE 3

For some of the films described in Example 1 the Haze is measured according to ASTM 1003. The results are listed in table 3.

TABLE 3
Haze measured according to ASTM 1003

| Adhesive layer of the film made of . . . | Haze [%] |
|---|---|
| Cast film, benchmark GHX 375 HQ from Bischoff + Klein | 18.6 |
| Plastomer with melting point 36° C. | 9.0 |
| Plastomer with melting point 71° C. | 8.8 |

The comparison shows that according to the invention it is possible to produce films with high tack and a high clarity or transparency.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. A self adhesive, coextruded multilayer surface protection film comprising a base layer and an adhesive layer, the adhesive layer consisting essentially of one or more copolymers of ethylene with one or more α-olefins having 4 to 10 carbon atoms, with a density of 0.86 g/cm³ to 0.90 g/cm³, whereby at least one of the copolymers has a peak melting temperature of ≦50° C.

2. A surface protection film according to claim 1, wherein, the peak melting point of the at least one copolymer is ≦40° C.

3. A surface protection film according to claim 1, wherein the adhesive layer comprises up to 95% of one or more copolymers of ethylene with an α-olefin containing 4 to 10 carbon atoms having a peak melting temperature between 50° C. and 120° C.

4. A surface protection film according to claim 1, wherein the base layer comprises polyethylene and/or polypropylene.

5. A surface protection film according to claim 1, further comprising an antiblock agent in the base layer.

6. A surface protection film according to claim 1, further comprising a third outer layer and an antiblock agent contained in the outer layer.

7. A surface protection film according to claim 1, further comprising a third inner layer containing a mineral filler.

8. A surface protection film according to claim 1, wherein the adhesive layer is corona treated.

9. A surface protection film according to claim 1, wherein the adhesive layer has a peel force, measured according to method described in Example 1, of at least 0.1 N/cm on a substrate comprised of polymethylmethacrylate, acrylonitrile-butadiene-styrene terpolymer, polystyrene, polycarbonate, and/or polyethylene terephthalate.

10. A surface protection film according to claim 9, wherein the peel force is at least 0.5 N/cm.

11. A surface protection film according to claim 1, wherein the adhesive layer has a haze value, measured according to ASTM D-1003, of less than 15.

12. A surface protection film according to claim 1 wherein the adhesive layer has a haze value, measured according to ASTM D-1003, of less than 10.

13. A surface protection film according to claim 1, wherein the multilayer film is a blown film.

14. A surface protection film according to of claim 1, wherein the multilayer film is a cast film.

15. A surface protection film according to claim 1, wherein at least one of the one or more copolymers contains at least 10% by weight, of comonomer comprising one or more α-olefins with 4 to 10 carbon atoms.

16. A surface protection film according to claim 1, wherein at least one of the one or more copolymers contains at least 20% by weight, of comonomer comprising one or more α-olefins with 4 to 10 carbon atoms.

17. A surface protection film according to claim 1, wherein at least one of the one or more copolymers contains at least 23% by weight, of comonomer comprising one or more α-olefins with 4 to 10 carbon atoms.

18. A self adhesive, coextruded multilayer surface protection film, comprising a base layer and an adhesive layer, the adhesive layer comprising one or more copolymers of ethylene with one or more α-olefins having 4 to 10 carbon atoms, with a density of 0.86 g/cm³ to 0.90 g/cm³, wherein at least one of the copolymers has a peak melting temperature of ≦50° C. and wherein the adhesive layer is substantially free from tackifiers and polymers other than copolymers of ethylene with one or more α-olefins.
